(19) United States
(12) Patent Application Publication
(10) Pub. No.: US 2022/0324417 A1
(43) Pub. Date: Oct. 13, 2022

(54) Holder for Wiper Arm, Wiper Assembly and Motor Vehicle

(71) Applicant: Taixiang Vehicle Replace Parts (Shenzhen) Co. Ltd., Shenzhen (CN)

(72) Inventors: Jian Zhang, Shenzhen (CN); Chuangchuang Pei, Shenzhen (CN)

(21) Appl. No.: 17/657,900

(22) Filed: Apr. 4, 2022

(30) Foreign Application Priority Data
Apr. 8, 2021 (CN) 202110376669.0

(51) Int. Cl. B60S 1/34

(52) U.S. Cl. CPC B60S 1/3488

(57) ABSTRACT

A holder for a wiper arm includes a body having two opposite sidewalls extending in the longitudinal direction of the wiper arm, the bottom of the body being provided with a dovetail slot configured to match a protrusion of an adapter. The holder further includes a fixing pin arranged between the two opposite sidewalls of the body, and a first locking pin and a second locking pin arranged in the two opposite sidewalls of the body respectively. The first locking pin and the second locking pin are equidistant from the fixing pin.

This application claims priority under 35 U.S.C. § 119 to patent application no. CN 202110376669.0, filed on Apr. 8, 2021 in China, the disclosure of which is incorporated herein by reference in its entirety.

### TECHNICAL FIELD

The present disclosure relates to the field of motor vehicle fittings, in particular to a holder for a wiper arm, a wiper assembly and a motor vehicle.

### BACKGROUND

As economies have rapidly developed and major advances have been made in technology, people have been demanding noticeably more in terms of quality of life. Compared with the past era of pedestrians and bicycles, motor vehicles appear to have become an indispensable means of transport in the lives of the people of today. In an era when motor vehicles are ubiquitous, people's demands in relation to motor vehicles are not limited to fuel economy and vehicle comfort; driving safety has also become a primary factor to be considered when purchasing a vehicle.

In terms of driving a motor vehicle, rainy and snowy weather not only cause slippery roads and increased braking distance; vision is the chief problem. When driving in rainy and snowy weather, rain and snow generally stick to the motor vehicle's front windscreen, rear windscreen, side windows and rear view mirrors, seriously affecting the driver's vision, and easily causing misjudgements which in turn cause accidents. Windscreen wipers are an important safety fitting on a motor vehicle, being able to effectively clear rain, snow and dirt from the motor vehicle's windscreen, to give the driver a clear field of view, thus ensuring driving safety. At present, in a wiper arm connection structure in the prior art, a holder for a wiper arm is only suitable for a flat wiper arm, by connecting the holder to an adapter, and then connecting the wiper arm to the holder. In the case of specific types of wiper arm, for example types in which an end of the wiper arm has an arc-shaped installation. groove (Roc-lock 3 series wiper arms), interference easily occurs between the wiper arm and the holder structure during installation, thus preventing smooth

Thus, a new type of holder for a wiper arm is urgently needed.

### SUMMARY

An object of the present disclosure is to solve or mitigate to a certain degree the technical problem mentioned above.

According to a first aspect of the present disclosure, a holder for a wiper arm is provided, comprising:
a body, having two opposite sidewalls extending in the longitudinal direction of the wiper arm, the bottom of the body being provided with a dovetail slot configured to match a protrusion of an adapter;
a fixing pin, arranged between the two opposite sidewalls of the body; and
a first locking pin and a second locking pin, arranged in the two opposite sidewalls of the body respectively, the first locking pin and the second locking pin being equidistant from the fixing pin.

Optionally, in the holder as described above, the first locking pin and the second locking pin are located at the same height.

Optionally, in the holder as described above, the range of distances from the first locking pin and the second locking pin to the fixing pin is 2.5-3 mm.

Optionally, in the holder as described above, respective ends of the first locking pin and the second locking pin are each provided with a bevelled guide face.

Optionally, in the holder as described above, the first locking pin and the second locking pin are the same size.

According to a second aspect of the present disclosure, a wiper assembly is provided, comprising the holder described above, the wiper assembly further comprising:
an adapter, fixed to a wiper blade and provided with a protrusion configured to match the dovetail slot of the holder; and
a wiper arm, an end thereof being rotatable around the fixing pin of the holder, wherein the end of the wiper arm is provided with arc-shaped grooves, and when the end of the wiper arm rotates around the fixing pin of the holder, the first locking pin and the second locking pin are engaged in the arc-shaped grooves.

Optionally, in the wiper assembly as described above, two notches arranged side by side are provided in each of the two opposite sidewalls of the body of the holder.

Optionally, in the wiper assembly as described above, the end of the wiper arm is provided with a slot matched to the shape of the fixing pin of the holder.

Optionally, in the wiper assembly as described above, the slot of the wiper arm has an elliptical cross section.

According to a third aspect of the present disclosure, a motor vehicle is provided, comprising the wiper assembly described above.

### BRIEF DESCRIPTION OF THE DRAWINGS

The content of the present disclosure will become easier to understand with reference to the drawings. Those skilled in the art will readily appreciate that these drawings are merely intended for explanatory purposes, and are not intended to limit the scope of protection of the present disclosure. In addition, similar numerals are used to indicate similar components in the drawings, wherein:

FIG. 1 shows demonstratively the structure of a holder for a wiper arm in accordance with the present disclosure.

FIG. 2 shows demonstratively the structure of the holder and an adapter in accordance with the present disclosure, viewed from below.

FIG. 3 shows demonstratively part of the structure of a wiper arm in accordance with the present disclosure.

FIG. 4 shows demonstratively the structure of a wiper assembly in accordance with the present disclosure, with the wiper arm omitted.

FIG. 5 shows demonstratively the structure of the wiper assembly in accordance with the present disclosure, when installing the wiper arm.

FIG. 6 shows demonstratively the structure of the wiper assembly in accordance with the present disclosure, when installation of the wiper arm is complete.

### DETAILED DESCRIPTION

To make the abovementioned object, features and advantages of the present disclosure easier to understand, specific embodiments of the present disclosure are explained in detail below with reference to the drawings. First of all, it must be explained that orientational terms mentioned or possibly mentioned herein, such as up, down, left, right, front, back, inside, outside, top and bottom, are defined in relation to the structures shown in the drawings, and are relative concepts, and might therefore vary with position and state of use. Thus, these or other orientational terms should not be interpreted as being restrictive terms.

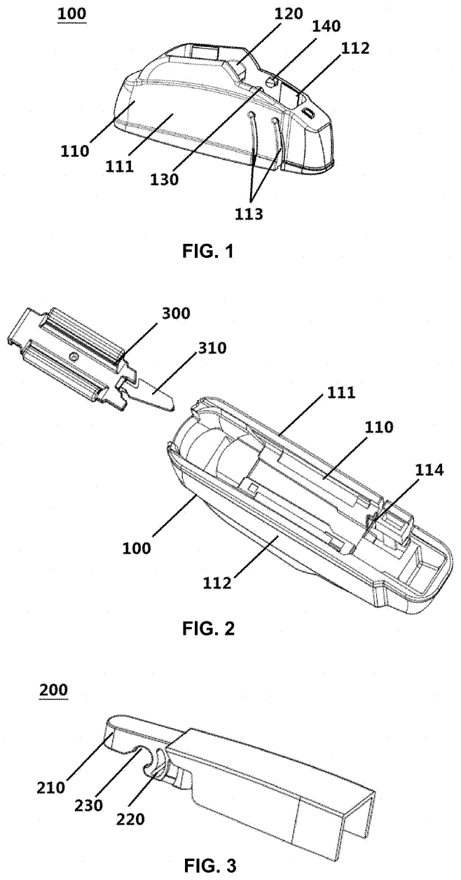

FIG. 1 shows a schematic structural drawing of a holder for a wiper arm disclosed in accordance with the present disclosure. Referring to FIG. 1, it can be seen that a holder 100 for a wiper arm comprises a body 110, a fixing pin 120, a first locking pin 130 and a second locking pin 140, etc. The body 110 has two opposite sidewalls 111, 112 extending in the longitudinal direction of a wiper arm 200. It can be seen in FIG. 2 that the bottom of the body 110 is also provided with a dovetail slot 114, which is configured to match a protrusion 310 of an adapter 300, to enable the holder 100 to be push-fitted onto the adapter 300. The fixing pin 120 is arranged between the two opposite sidewalls 111, 112 of the body 110. The first locking pin 130 and the second locking pin 140 are arranged in the two opposite sidewalls 111, 112 of the body 110 respectively, and the first locking pin 130 and the second locking pin 140 are equidistant from the fixing pin 120. It must be explained that in this text, “longitudinal” means the length direction of the wiper arm 200. In the holder for a wiper arm according to the present disclosure, the non-interfering structure of the first locking pin 130 and the second locking pin 140 makes the mounting and removal of Roc-lock 3 series wiper arms very easy.

In some embodiments of the present disclosure, the first locking pin 130 and the second locking pin 140 are located at the same height, as shown in FIG. 1.

In some embodiments of the present disclosure, the range of distances from the first locking pin 130 and the second locking pin 140 to the fixing pin 120 may be designed to be 2.5-3 mm.

In some embodiments of the present disclosure, respective ends of the first locking pin 130 and second locking pin 140 of the holder 100 are each provided with a beveled guide face (see FIG. 1), so as to facilitate the mounting of the wiper arm 200.

In some embodiments of the present disclosure, the first locking pin 130 and the second locking pin 140 may be designed to be the same size.

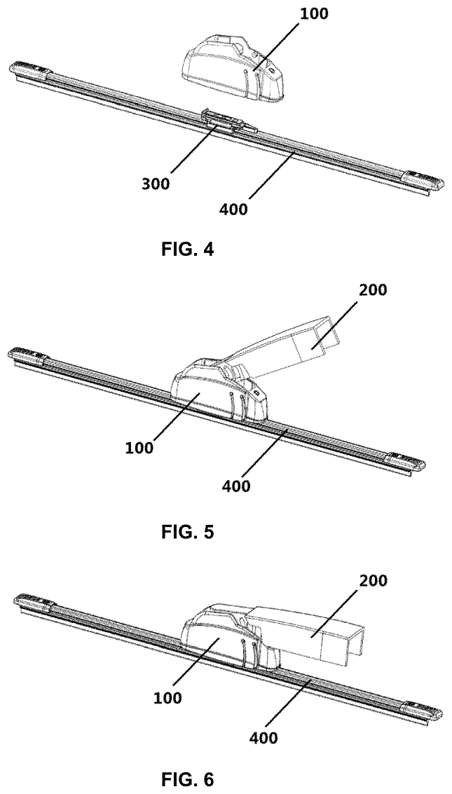

FIGS. 4-6 show schematic structural drawings of a wiper assembly disclosed in accordance with the present disclosure. Referring to FIGS. 4-6, it can be seen that the wiper assembly comprises the holder 100, the wiper arm 200, the adapter 300 and a wiper blade 400, wherein the adapter 300 is fixed to the wiper blade 400, and is provided with the protrusion 310 matched to the dovetail slot 114 of the holder 100. An end 210 of the wiper arm 200 is rotatable around the fixing pin 120 of the holder 100. The end 210 of the wiper arm 200 is provided with arc-shaped grooves 220 (see FIG. 3); when the end 210 of the wiper arm 200 rotates around the fixing pin 120 of the holder 100, the first locking pin 130 and the second locking pin 140 are engaged in the arc-shaped grooves 220, thereby advantageously locking the first locking pin 130 and the second locking pin 140 in the arc-shaped grooves 220.

In some embodiments of the present disclosure, two notches 113 arranged side by side are provided in each of the two opposite sidewalls 111, 112 of the body 110 of the holder 100. When an operator removes the holder 100 from the adapter 300, he or she need only press a tab formed between the two notches 113 arranged side by side.

In some embodiments of the present disclosure, the wiper arm 200 is provided with a slot 230 matched to the shape of the fixing pin 120 of the holder 100, thereby making it easier for the end 210 of the wiper arm 200 to pivot around the fixing pin 120.

In some embodiments of the present disclosure, the slot 230 of the wiper arm 200 has a substantially elliptical cross section, as shown in FIG. 3.

The processes of assembling and disassembling the adapter 300, the wiper arm 200 and the holder 100 for the wiper arm 200 in the wiper assembly are expounded below with reference to FIGS. 4-6.

In the process of installing the holder 100, the holder 100 is first of all plugged onto the adapter 300 fixed to the wiper blade 400 by mating the protrusion 310 with the dovetail slot 114 (see FIG. 4). The slot 230 of the wiper arm 200 is then aligned with the fixing pin 120 of the holder 100, and the wiper arm 200 is rotated downwards around the fixing pin 120 of the holder 100 (see FIG. 5), thereby engaging the first locking pin 130 and second locking pin 140 of the holder 100 in the arc-shaped grooves 220 of the wiper arm 200, and in turn locking the first locking pin 130 and second locking pin 140 in the arc-shaped grooves 220 respectively, at which time the installation of the wiper arm 200 is complete (see FIG. 6). In the process of removing the holder 100, the wiper arm 200 is rotated upwards around the fixing pin 120 of the holder 100, and the wiper arm 200 is moved away from the fixing pin 120 of the holder 100, thereby disengaging the first locking pin 130 and second locking pin 140 of the holder 100 from the arc-shaped grooves 220 of the wiper arm 200, at which time the removal of the wiper arm 200 is complete.

The present disclosure also provides a motor vehicle. The motor vehicle comprises the wiper assembly described above. The motor vehicle may be various types of vehicles such as a private car, a taxi, a bus, a medium-sized coach or a large coach.

In summary, the holder for a wiper arm according to the present disclosure has a simple, optimized structural design, so that in addition to flat wiper arms, other types of wiper arms (e.g. Roc-lock 3 series wiper arms) can also be fitted to the holder, thereby achieving a good connection result and a good wiping/cleaning effect, and thus effectively extending the service life of the wiper. Thus, it is strongly recommended that this holder for a wiper arm be used in a wiper assembly, and it is recommended that the use of this wiper assembly in motor vehicles be popularized.

A number of specific embodiments have been set out above to expound in detail the holder for a wiper arm, the wiper assembly and the motor vehicle according to the present disclosure. These examples merely serve the purpose of explaining the principles of the present disclosure and embodiments thereof, without restricting the present disclosure. Those skilled in the art could make various changes and improvements without departing from the spirit and scope of the present disclosure. Thus, all equivalent technical solutions should be included in the scope of the present disclosure and are defined by the claims thereof

1. A holder for a wiper arm, comprising:
a body having two opposite sidewalls extending in a longitudinal direction of the wiper arm, a bottom of the body defining a dovetail slot configured to match a protrusion of an adapter;
a fixing pin arranged between the two opposite sidewalls of the body;
a first locking pin arranged in a first sidewall of the two opposite sidewalls; and
a second locking pin arranged in a second sidewall of the two opposite sidewalls, the first locking pin and the second locking pin being equidistant from the fixing pin.

2. The holder according to claim 1, wherein the first locking pin and the second locking pin are located at the same height.

3. The holder according to claim 1, wherein a distance from the first locking pin to the fixing pin and from the second locking pin to the fixing pin is in a range of from 2.5-3 mm.

4. The holder according to claim 1, wherein respective ends of the first locking pin and the second locking pin each have a beveled guide face.

5. The holder according to claim 1, wherein the first locking pin and the second locking pin are the same size.

6. A wiper assembly, comprising:
a holder comprising:
a body having two opposite sidewalls extending in a longitudinal direction of the wiper arm, a bottom of the body defining a dovetail slot configured to match a protrusion of an adapter;
a fixing pin arranged between the two opposite sidewalls of the body;
a first locking pin arranged in a first sidewall of the two opposite sidewalls; and
a second locking pin arranged in a second sidewall of the two opposite sidewalls,
the first locking pin and the second locking pin being equidistant from the fixing pin;
an adapter fixed to a wiper blade and including a protrusion configured to match the dovetail slot of the holder; and
a wiper arm having an end that is rotatable around the fixing pin of the holder,
wherein the end of the wiper arm defines arc-shaped grooves and is configured such that, when the end of the wiper arm rotates around the fixing pin of the holder, the first locking pin and the second locking pin are engaged in the arc-shaped grooves.

7. The wiper assembly according to claim 6, wherein each of the first and second sidewalls defines two notches arranged side by side.

8. The wiper assembly according to claim 6, wherein the end of the wiper arm defines a slot matched to a shape of the fixing pin of the holder.

9. The wiper assembly according to claim 8, wherein the slot of the wiper arm has an elliptical cross section.

10. A motor vehicle, comprising:
a wiper assembly including:
a holder comprising:
a body having two opposite sidewalls extending in a longitudinal direction of the wiper arm, a bottom of the body defining a dovetail slot configured to match a protrusion of an adapter;
a fixing pin arranged between the two opposite sidewalls of the body;
a first locking pin arranged in a first sidewall of the two opposite sidewalls; and
a second locking pin arranged in a second sidewall of the two opposite sidewalls, the first locking pin and the second locking pin being equidistant from the fixing pin;
an adapter fixed to a wiper blade and including a protrusion configured to match the dovetail slot of the holder; and
a wiper arm having an end that is rotatable around the fixing pin of the holder,
wherein the end of the wiper arm defines arc-shaped grooves and is configured such that, when the end of the wiper arm rotates around the fixing pin of the holder, the first locking pin and the second locking pin are engaged in the arc-shaped grooves.
